(19) United States
(12) Patent Application Publication
(10) Pub. No.: US 2002/0080456 A1
(43) Pub. Date: Jun. 27, 2002

(54) Input interruption detecting circuit of optical receiver

(76) Inventors: Atsushi Suda, Yokohama (JP); Kazuhiro Suzuki, Yokohama (JP); Tomoyuki Otsuka, Kawasaki (JP); Hiroshi Yamada, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/844,887

(22) Filed: Apr. 27, 2001

(30) Foreign Application Priority Data
Dec. 25, 2000 (JP) 2000-393082

(51) Int. Cl. H04B 10/00; H04B 10/06

(52) U.S. Cl. 359/189; 359/161

(57) ABSTRACT

The present invention provides an input interruption detecting circuit of an optical receiver that realizes a circuit structure that avoids erroneous synchronization due to an influence of a synchronous noise, and enables an accurate detection of an input interruption, with respect to input interruption detection based on the synchronous or asynchronous state of a PLL circuit. To this end, the input interruption detecting circuit of an optical receiver according to the invention is one which is provided with a noise superimposition section which superimposes an asynchronous noise having frequency components that make the PLL circuit asynchronous, onto a signal input to a phase comparator of the PLL circuit, in a circuit structure for performing input interruption detection based on the synchronous state of a PLL circuit. As a result, at the time of an input interruption of the optical signal, the PLL circuit is hardly influenced by the synchronous noise, and it enters an asynchronous state due to the influence of the asynchronous noise, thus enabling accurate input interruption detection.

### BACKGROUND OF THE INVENTION

1. Field of the Invention

The present invention relates to an input interruption detecting circuit of an optical receiver used for optical communication, and more particularly relates to an input interruption detecting circuit of an optical receiver for detecting an input interruption of an optical signal, based on the synchronous or asynchronous state of a phase locked loop (PLL) circuit.

2. Description of the Related Art

The construction of optical receivers used for optical communication typically includes an input interruption detecting circuit for detecting an optical input interruption due to the reception conditions of the optical signal input via a transmission path or the like. For a conventional input interruption detecting circuit, for example, as shown in Japanese Unexamined Patent Publication No. 59-114925, there is a construction in which an input interruption of an optical signal is detected based on the synchronous or asynchronous state of a phase locked loop (PLL) circuit which generates a timing signal (clock signal) on the basis of a received optical signal.

FIG. 22 is a block diagram showing a structural example of an optical receiver incorporating a conventional input interruption detecting circuit as described above.

In the structural example of FIG. 22, an optical signal input to an optical receiver via an external transmission path or the like is received by a photodetector 1, converted to an electrical signal, and amplified by a preamplifier 2. The output signal of the preamplifier 2 is further amplified to a required level by a main amplifier 3 and a limiting amplifier 4, and then is input to a phase comparator 5. The phase comparator 5, together with a charge pump 6, a low pass filter (LPF) 7 and a voltage controlled oscillator (VCO) 8, constitutes a PLL circuit. The phase comparator 5, performs phase comparison between an output signal Q and an inverse output signal /Q from the limiting amplifier 4, and an output signal from the voltage controlled oscillator 8, and sends a signal corresponding to a phase difference therebetween to the voltage controlled oscillator 8 via the charge pump 6 and the low pass filer 7, to thereby variably control an oscillating frequency of the voltagecontrolled oscillator 8. Then, the output signal of the voltage controlled oscillator 8 is sent as a clock signal CLK to a flip-flop circuit (F/F) 9, and in accordance with the clock signal CLK, data identification processing of the received optical signal passed through the phase comparator 5 is carried out, and data signals indicative of an identification result and the clock signal CLK are output to outside from the flip-flop circuit 9 via a data output terminal OUT_{DATA} and a clock output terminal OUT_{CLK} respectively. Furthermore, the synchronous or asynchronous state of the PLL circuit is monitored by a lock detector 10, for example by using a signal output from the low pass filter 7, and when an asynchronous state of the PLL circuit is detected, an optical signal input interruption is judged by an input interruption detecting circuit 11, and an input interruption detection alarm signal is output from an alarm output terminal OUT_{ALM} to outside. Such a construction where the input interruption detection is performed based on the synchronous or asynchronous state of the PLL circuit, is effective from the point of enabling circuit miniaturization and a reduction in power.

However, with the conventional input interruption detecting circuit as mentioned above, there is a deficiency in that when the PLL circuit erroneously synchronizes due to an influence of noise from peripheral circuits or the like, even in the case where the input of a desired optical signal interrupts, the input interruption detection alarm signal is not output. In general, with an optical communication system, since there are many cases where the output signal of the optical receiver as shown in FIG. 22 is used by being divided into frequencies with ½^{N} (N=2, 3, 4, . . . ) of bit rates thereof, there exist in the periphery of the optical receiver many data signals and clock signals having the same frequency as that at which the PLL circuit synchronizes. Hence, there is a very high possibility that such signals leak into the optical receiver as noise. Consequently, the PLL circuit erroneously synchronizes due to the influence of noise (referred to hereunder as synchronous noise) with the same frequency as that at which the PLL circuit synchronizes, and hence there is a problem in that erroneous input interruption detection is carried out.

### SUMMARY OF THE INVENTION

The present invention addresses the abovementioned point, with the object of providing an input interruption detecting circuit of an optical receiver that realizes a circuit structure that avoids erroneous synchronization due to an influence of synchronous noise, and enables an accurate detection of an input interruption, with respect to an input interruption detection based on the synchronous or asynchronous state of a PLL circuit.

To achieve the abovementioned object, the input interruption detecting circuit of an optical receiver according to a first aspect of the invention is an input interruption detecting circuit of an optical receiver for detecting an input interruption of an optical signal based on the synchronous or asynchronous state of a phase locked loop (PLL) circuit which generates a timing signal using a received optical signal, comprising a noise superimposition section which superimposes an asynchronous noise having frequency components that make the PLL circuit asynchronous, onto a signal input to a phase comparator of the PLL circuit. Here, it is preferable to set a level of the abovementioned asynchronous noise to be higher than a level of a synchronous noise for which an erroneous operation is to be prevented.

With such a construction, the asynchronous noise that enters the PLL circuit an asynchronous state is superimposed onto the input signal of the phase comparator. Therefore, at the time of an input interruption of the optical signal, the PLL circuit is hardly influenced by the synchronous noise, and it enters the asynchronous state due to the influence of the asynchronous noise. As a result, the input interruption of the optical signal can be detected accurately based on the synchronous or asynchronous state of the PLL circuit.

Furthermore, the input interruption detecting circuit of an optical receiver according to a second aspect of the invention is an input interruption detecting circuit of an optical receiver for detecting an input interruption of an optical signal based on the synchronous or asynchronous state of a phase locked loop (PLL) circuit which generates a timing signal using a received optical signal, comprising a sensitivity control section for adjusting the sensitivity of a phase comparator of the PLL circuit.

With such a construction, by controlling so that the sensitivity of the phase comparator is reduced depending on the amplitude of the synchronous noise for example, the PLL circuit does not erroneously synchronize due to the synchronous noise even at the time of an input interruption of the optical signal. Therefore, the input interruption of the optical signal can be detected accurately based on the synchronous or asynchronous state of the PLL circuit.

Moreover, the input interruption detecting circuit of an optical receiver according to a third aspect of the invention is an input interruption detecting circuit of an optical receiver for detecting an input interruption of an optical signal based on the synchronous or asynchronous state of the phase locked loop (PLL) circuit which generates a timing signal using a received optical signal, comprising a duty control section for controlling a duty ratio of a signal input to a phase comparator of the PLL circuit.

With such a construction, by controlling the duty ratio of the input signal to the phase comparator depending on a spectrum of the synchronous noise for example, the power of the center frequency component of the abovementioned input signal becomes small, and the PLL circuit does not erroneously synchronize due to the synchronous noise even at the time of an input interruption of the optical signal. Therefore, the input interruption of the optical signal can be detected accurately based on the synchronous or asynchronous state of the PLL circuit.

Other objects, features and advantages of this invention will become apparent in the following description of the embodiments related to the appended drawings.

### BRIEF DESCRIPTION OF THE DRAWINGS

FIG. 1 is a block diagram showing a first basic structure of an input interruption detecting circuit of an optical receiver according to the present invention.

FIG. 2 is a block diagram showing a modified example of the first basic structure shown in FIG. 1.

FIG. 3 is a block diagram showing the structure of an embodiment 1-1 of an optical receiver to which the first basic structure of the present invention is applied.

FIG. 4 is a block diagram showing a modified example of the embodiment 1-1 shown in FIG. 3.

FIG. 5 is a block diagram showing the structure of an embodiment 1-2 of an optical receiver to which the first basic structure of the present invention is applied.

FIG. 6 is a block diagram showing a modified example of the embodiment 1-2 shown in FIG. 5.

FIG. 7 is a block diagram showing a modified example of the circuit structure shown in FIG. 6.

FIG. 8 is a block diagram showing a second basic structure of an input interruption detecting circuit of an optical receiver according to the present invention.

FIG. 9 is a block diagram showing a modified example of the second basic structure shown in FIG. 8.

FIG. 10 is a block diagram showing the structure of an embodiment 2-1 of an optical receiver to which the second basic structure of the present invention is applied.

FIG. 11 is a diagram for explaining a change in effective amplitude by application of an offset voltage in the embodiment 2-1.

FIG. 12 is a block diagram showing a modified example of the embodiment 2-1 shown in FIG. 10.

FIG. 13 is a block diagram showing the structure of an embodiment 2-2 of an optical receiver to which the second basic structure of the present invention is applied.

FIG. 14 is a block diagram showing a modified example of the embodiment 2-2 shown in FIG. 13.

FIG. 15 is a block diagram showing a third basic structure of an input interruption detecting circuit of an optical receiver according to the present invention.

FIG. 16 is a diagram for explaining a change in a spectrum by control of a duty ratio in the third basic structure of the present invention.

FIG. 17 is a block diagram showing a modified example of the third basic structure shown in FIG. 15.

FIG. 18 is a block diagram showing the structure of an embodiment 3-1 of an optical receiver to which the third basic structure of the present invention is applied.

FIG. 19 is a block diagram showing a modified example of the embodiment 3-1 shown in FIG. 18.

FIG. 20 is a block diagram showing the structure of an embodiment 3-1 of an optical receiver to which the third basic structure of the present invention is applied.

FIG. 21 is a block diagram showing a modified example of the embodiment 3-1 shown in FIG. 20.

FIG. 22 is a block diagram showing the structure of a conventional input interruption detecting circuit of an optical receiver.

### DETAILED DESCRIPTION OF THE INVENTION

As follows is a description of embodiments of the present invention based on the drawings.

Firstly, the basic structure of an input interruption detecting circuit of an optical receiver according to the present invention will be described.

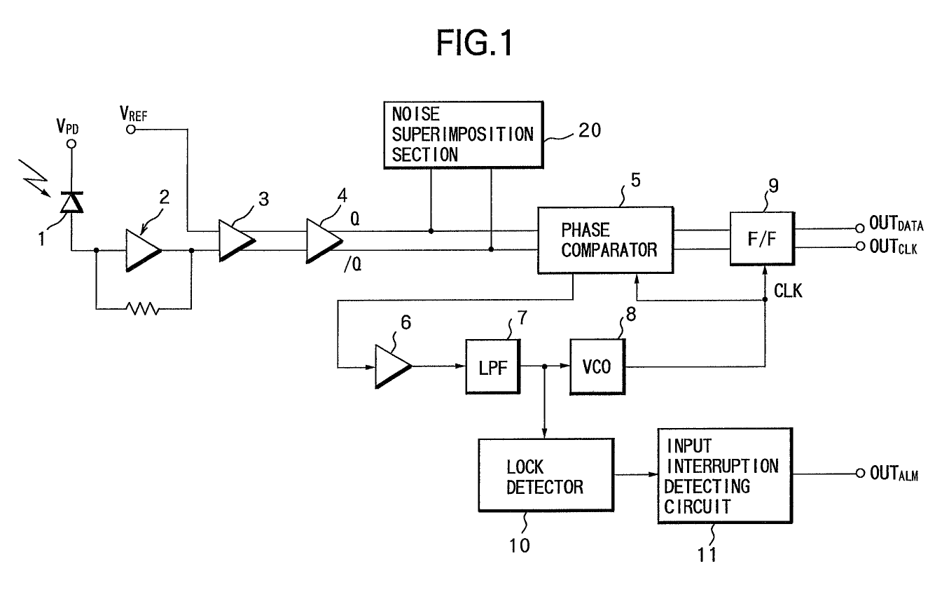

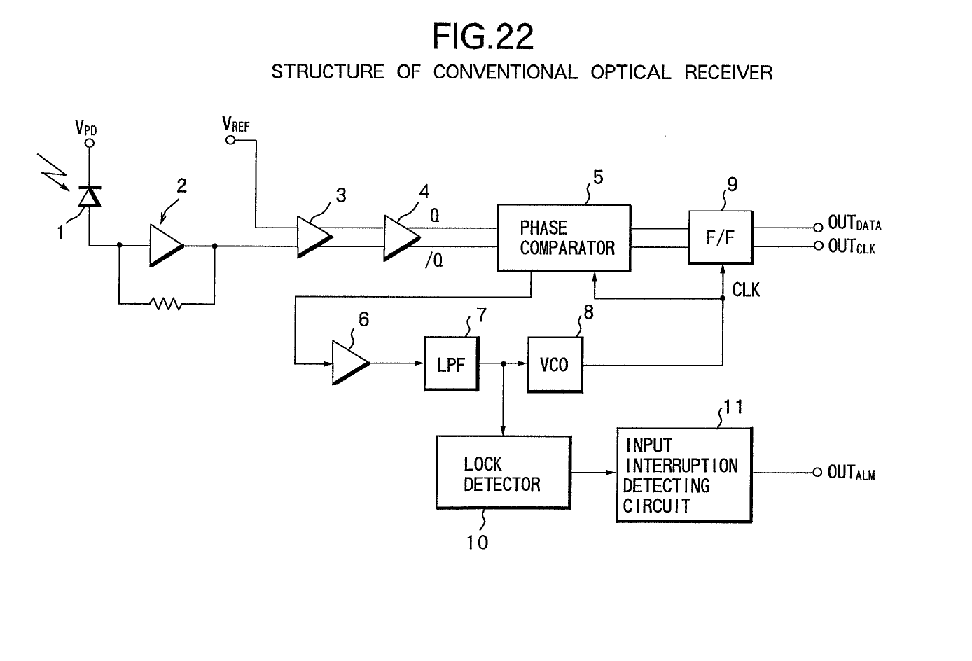

FIG. 1 is a block diagram showing one example of an optical receiver incorporating a first basic structure of the present invention. Here, the same symbols are given to the same parts as in the conventional construction shown in the abovementioned FIG. 22.

In FIG. 1, a first basic structure of the present invention is characterized in that the circuit structure for performing an input interruption detection based on the synchronous or asynchronous state of a PLL circuit is provided with a noise superimposition section 20 for superimposing a noise having frequency components that make the PLL circuit asynchronous (hereunder asynchronous noise), onto a signal input to a phase comparator 5. Furthermore, a level of noise to be superimposed is preferably set to be higher than a level of a synchronous noise for which an erroneous operation is to be prevented.

The noise superimposition section 20, for example, superimposes the asynchronous noise onto an output signal Q and an inverse output signal /Q sent to the phase comparator 5 from a limiting amplifier 4. Here, the position of the superimposition of the asynchronous noise is not limited to the position between the limiting amplifier 4 and the phase comparator 5, and can be at any arbitrary position between a photodetector 1 and the phase comparator 5, where a synchronous noise can be superimposed onto the received optical signal. Furthermore, it is preferable that a level of the asynchronous noise is set to be sufficiently lower than a level of the received optical signal.

The photodetector 1 is for receiving an optical signal input to the optical receiver via an external transmission path or the like, to convert it into an electrical signal. For this photodetector, for example, an avalanche photodiode (APD), a PIN photodiode or the like can be used. Here, the reverse bias applied to the photodetector 1 is designated to be V_{PD}. A preamplifier 2 is a known preamplifier that converts the electrical signal generated by the photodetector 1 into a voltage signal for amplification to a required level, to output this. A main amplifier 3 amplifies the signal output from the preamplifier 2 to a predetermined level depending on a reference voltage V_{REF}, to output this. Furthermore, the limiting amplifier 4 further amplifies the signal output from the main amplifier 3, to send an output signal Q and an inverse output signal /Q to the phase comparator 5 in the PLL circuit.

The PLL circuit comprises the phase comparator 5, a charge pump 6, a low pass filter (LPF) 7 and a voltage controlled oscillator (VCO) 8. The phase comparator 5 performs a phase comparison between the signals Q, /Q and an output signal from the voltage controlled oscillator 8, and sends a signal corresponding to a phase difference therebetween to the voltage controlled oscillator 8 via the charge pump 6 and the low pass filter 7, to thereby variably control an oscillating frequency of the voltage controlled oscillator 8.

A flip-flop circuit (F/F) 9 executes data identification processing of a received signal passed through the phase comparator 5, in accordance with a clock signal CLK output from the voltage controlled oscillator 8, and outputs a data signal indicative of an identification result and clock signal CLK to outside via a data output terminal OUT_{DATA} and a clock output terminal OUT_{CLK} respectively.

A lock detector 10 monitors, for example, the synchronous or asynchronous state of the PLL circuit by using a signal output from the low pass filter 7. For example, if a level of the output signal of the low pass filter 7 becomes outside of a predetermined range, it is judged to be asynchronous. Here, it is possible to set the abovementioned predetermined range used for judgment of the synchronous or asynchronous state, for example to a range in the vicinity of the level of the signal output from the low pass filter 7 when the PLL circuit is in synchronization with a desired signal.

When the lock detector 10 detects that the PLL circuit is in an asynchronous state, an input interruption detecting circuit 11 judges an optical signal input interruption, and outputs an input interruption detection alarm signal to outside via an alarm output terminal OUT_{ALM}.

With an optical receiver incorporating the first basic structure as described above, in the case where an optical signal input is interrupted, the synchronous noise having a frequency component to which the PLL synchronizes, and the asynchronous noise from the noise superimposition section 20 are sent as input signals to the phase comparator 5, and phases thereof are compared with a phase of a feedback signal from the voltage controlled oscillator 8. At this time, if the level of asynchronous noise is greater than the level of the synchronous noise, the PLL circuit enters an asynchronous state due to the asynchronous noise, and the state of erroneous synchronization due to the influence of the synchronous noise is avoided. In this manner, it is detected at the lock detector 10 that the PLL circuit is in the asynchronous state, and an input interruption of the optical signal is judged at the input interruption detecting circuit 11, so that an input interruption detection alarm signal is output via the alarm output terminal OUT_{ALM} to outside. On the other hand, in the situation where an optical signal is input into the optical receiver, if the level of the asynchronous noise is set to be sufficiently lower than the level of the received optical signal input to the phase comparator 5, the PLL circuit enters a synchronous state due to the received optical signal, and hence a clock signal CLK of a desired frequency is generated.

As is seen above, with the first basic structure of the present invention, since the noise superimposition section 20 is provided to superimpose the asynchronous noise onto the signal input to the phase comparator 5, the PLL circuit is hardly influenced by the synchronous noise at the time of an input interruption of the optical signal, and enters an asynchronous state due to the influence of the asynchronous noise. Therefore, it is possible to accurately detect an input interruption of the optical signal based on the synchronous or asynchronous state of the PLL circuit. Furthermore, by adjusting the level of the asynchronous noise, it is also possible to appropriately set the input light level at which the input interruption detection alarm signal is generated.

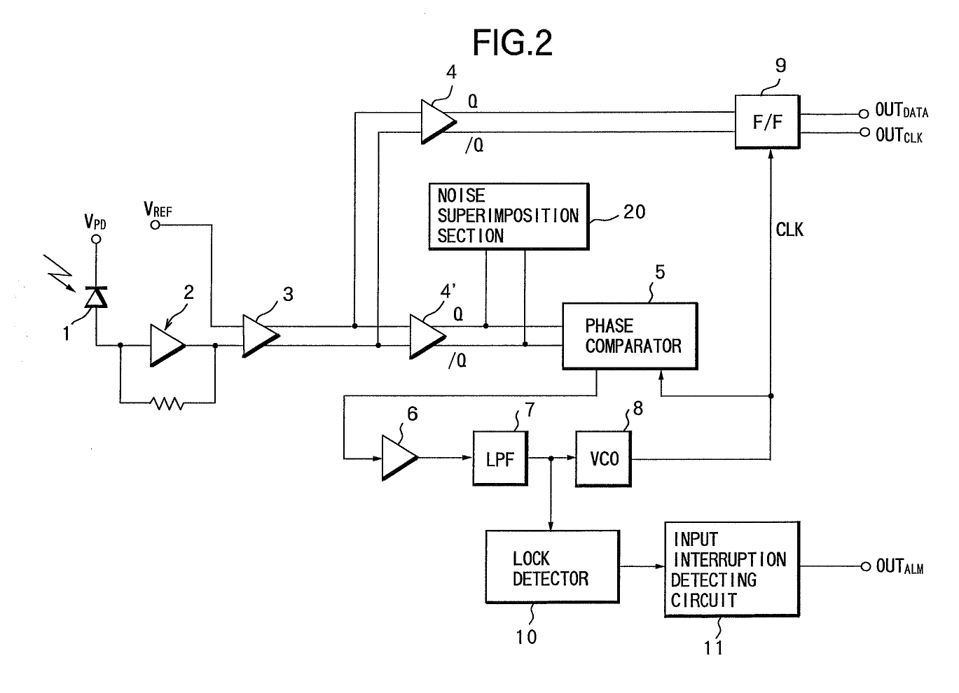

With the first basic structure as shown in the abovementioned FIG. 1, the received signal superimposed with the asynchronous noise is sent to the flip-flop 9 via the phase comparator 5. Therefore, there is also a possibility of a situation where the influence of the asynchronous noise on a main signal in the data identification processing or the like, needs to be considered. The block diagram in FIG. 2 shows a modified example of the first basic structure to deal with such a situation.

In the modified example in FIG. 2, the output signal of the main amplifier 3 is branched into two paths. The signal that is transmitted through one path is sent to the flip-flop 9 via the limiting amplifier 4, and the signal that is transmitted through the other path is sent to the phase comparator 5 via a limiting amplifier 4′. Thus, if the received signal to be sent to the PLL circuit is separated from the main signal system path where data identification processing is performed, and is superimposed with the asynchronous noise, it is possible to perform data identification processing of the received signal without any influence due to the asynchronous noise.

Here is a description of a specific embodiment to which the first basic structure as mentioned above is applied.

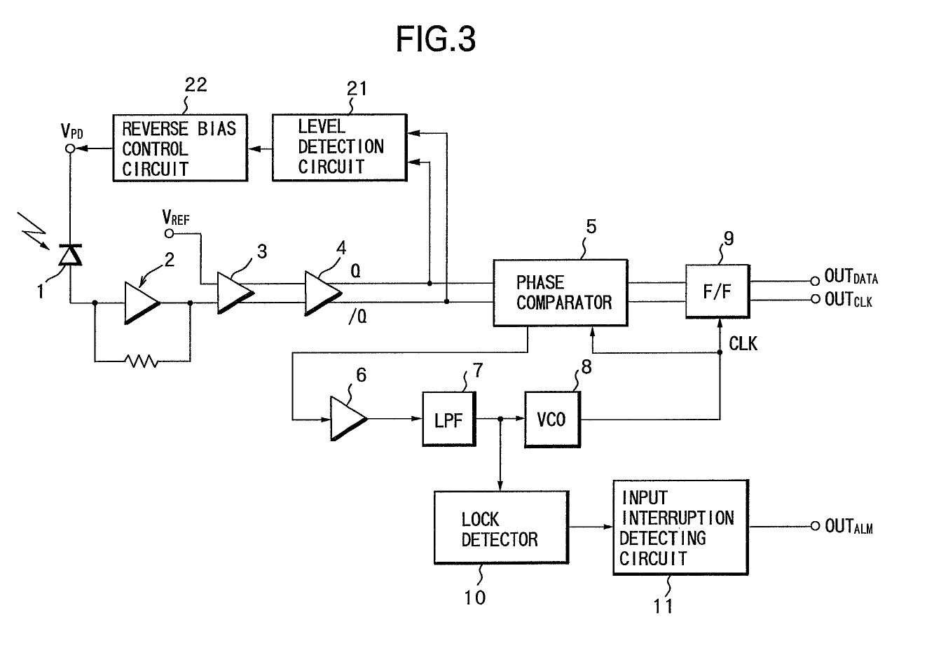

FIG. 3 is a block diagram showing the structure of an embodiment 1-1 of an optical receiver to which the first basic structure is applied.

In FIG. 3, the optical receiver of the embodiment 1-1 is provided with a level detection circuit 21 and a reverse bias control circuit 22 as a specific circuit structure of the noise superimposition section 20 in the first basic structure shown in the aforementioned FIG. 1. Here, an APD is used as the photodetector 1.

The level detection circuit 21 detects for example, a level of the signal sent to the phase comparator 5 from the limiting amplifier 4 and transmits a detection result to the reverse bias control circuit 22. The reverse bias control circuit 22 controls the reverse bias V_{PD} to be applied to the photodetector (APD) 1, depending on the detection result of the level detection circuit 21. More specifically, when judged based on the detection result of the level detection circuit 21, that the level of the optical signal input to the present optical receiver has fallen to a level corresponding to an input interruption, a value of the reverse bias V_{PD} is increased to increase a multiplication factor M of the photodetector (APD) 1. In this manner, a noise caused by dark current generated in the photodetector (APD) 1 is increased, and the noise from this dark current as the aforementioned asynchronous noise is output from the photodetector 1, successively amplified by the preamplifier 2, the main amplifier 3 and the limiting amplifier 4, and then output to the phase comparator 5. Here, it is preferable to set the reverse bias V_{PD} for when the input light level reaches a level corresponding to an input interruption, so as to correspond to the multiplication factor M of the photodetector (APD) 1 where the level after the dark current generated in the photodetector (APD) 1 is amplified by each of the amplifiers 2 to 4 is greater than the level of the synchronous noise being an object for which erroneous operation is to be prevented.

In this manner, at the time of an input interruption of the optical signal, the PLL circuit enters an asynchronous state easily due to the asynchronous noise where dark current of the photodetector (APD) 1 is used, and erroneous synchronization due to the influence of the synchronous noise is avoided, thus enabling accurate input interruption detection.

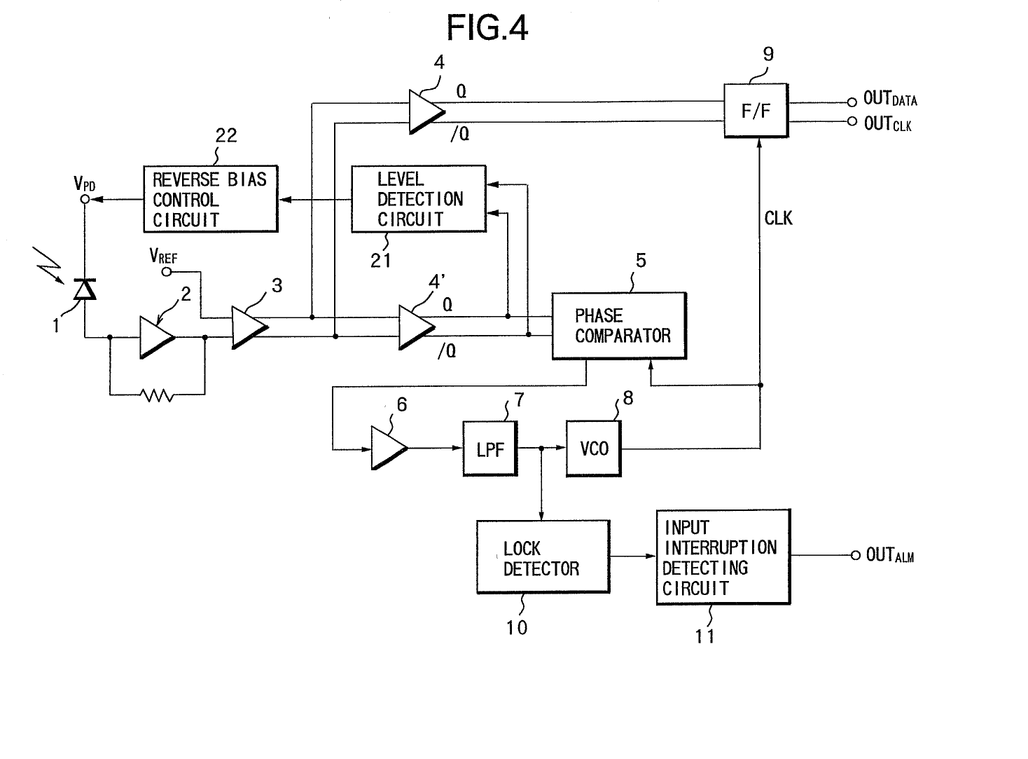

Note, a specific example corresponding to the aforementioned circuit structure shown in FIG. 1 is given in the above-described embodiment 1-1. However, a circuit structure as shown in FIG. 2, wherein the influence of the asynchronous noise on the main signal is considered, can also be applied similarly. A specific circuit structure of this case is shown in the block diagram of FIG. 4. In FIG. 4, for example, the circuit structure is such that the level of the signal sent to the phase comparator 5 from the limiting amplifier 4′ is detected at the level detection circuit 21.

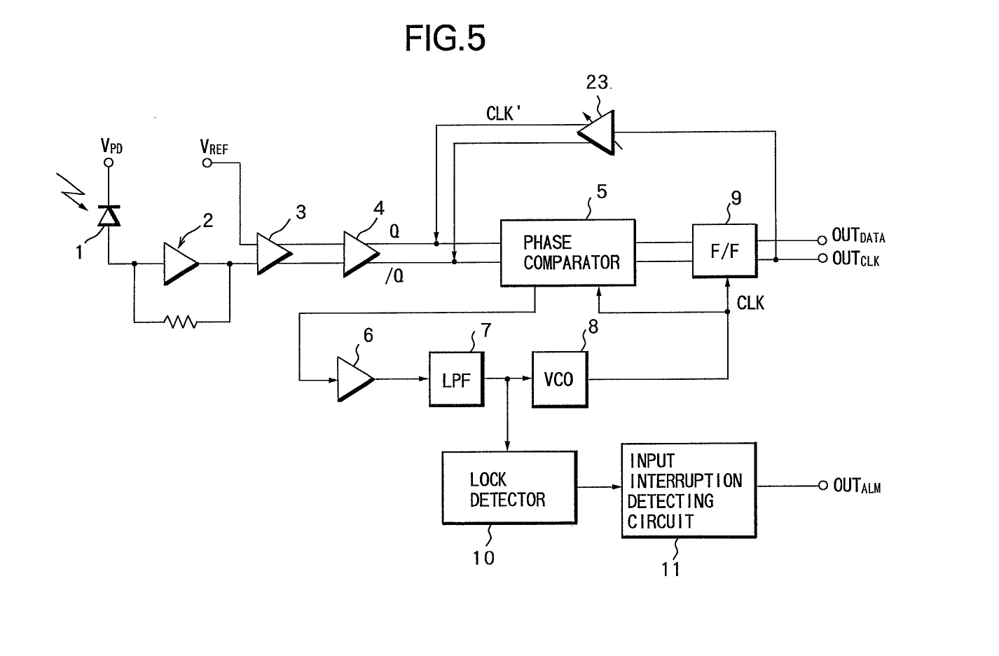

FIG. 5 is a block diagram showing the structure of an embodiment 1-2 of an optical receiver to which the first basic structure is applied.

In FIG. 5, the optical receiver of the embodiment 1-2 is provided with an amplifier 23 as a specific circuit structure of the noise superimposition section 20 in the first basic structure shown in the aforementioned FIG. 1. This amplifier 23 branches the clock signal CLK output from the flip-flop 9 and amplifies to a required level and superimposes the amplified clock signal CLK′, as the asynchronous noise, onto the output signal Q and inverse output signal /Q, which are transmitted to the phase comparator 5 from the limiting amplifier 4. It is preferable to set the amplification operation of the amplifier 23 such that a level of the clock signal CLK′ is greater than the level of the synchronous noise for which the influence of the erroneous operation is to be prevented.

The clock signal CLK output from the flip-flop 9 has a frequency corresponding to a bit rate of the received optical signal. This frequency corresponds to twice the synchronous frequency of the PLL circuit, to enter the PLL circuit an asynchronous state. Accordingly, the amplified clock signal CLK′ is superimposed onto the input signal to the phase comparator 5, and thus the PLL circuit enters an asynchronous state easily by the abovementioned clock signal CLK′ when input of the optical signal is interrupted. Therefore, erroneous synchronization due to the influence of the synchronous noise is avoided, thus enabling accurate input interruption detection.

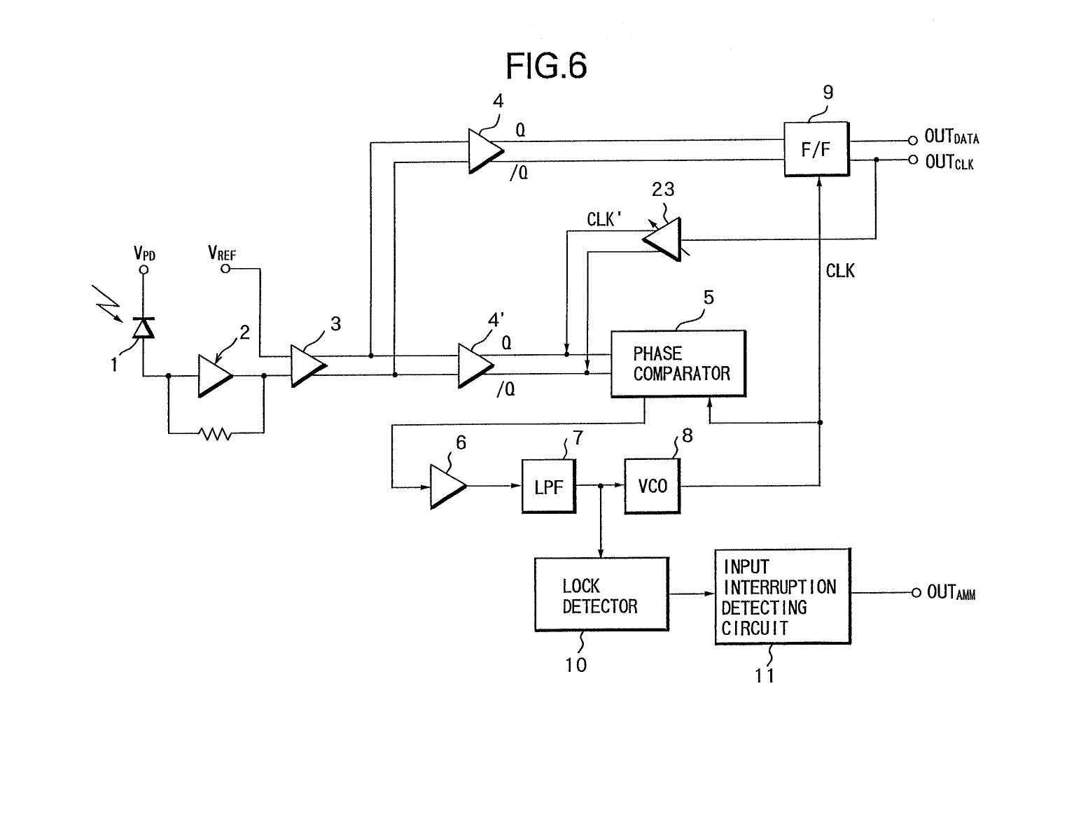

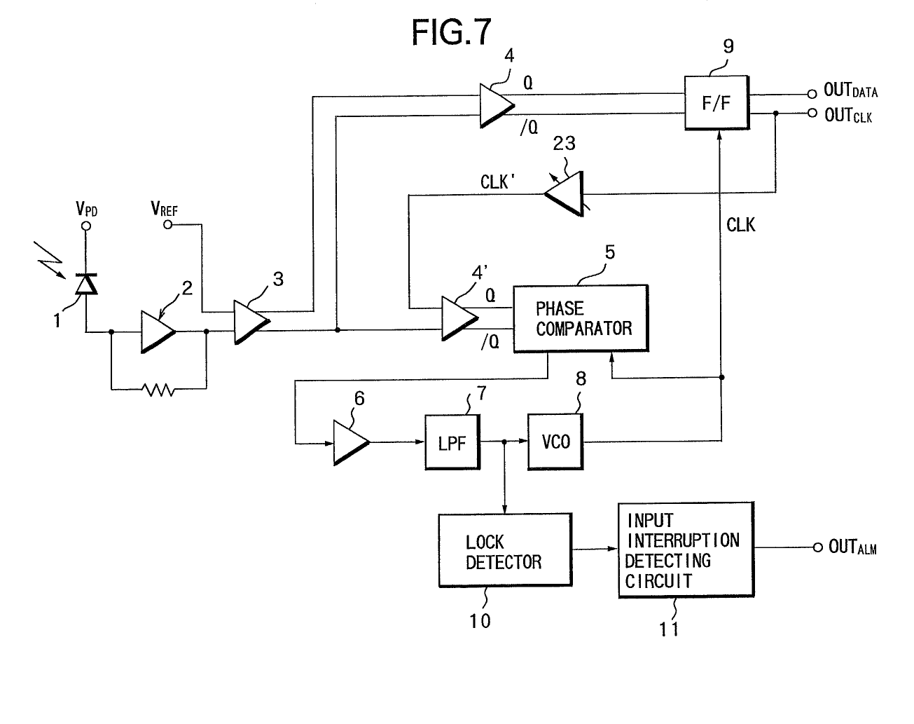

Note, a specific example corresponding to the aforementioned circuit structure shown in FIG. 1 is given in the above-described embodiment 1-2. However, a circuit structure as shown in FIG. 2, wherein the influence of the asynchronous noise on the main signal is considered, can also be applied similarly. A specific circuit structure of this case is shown in the block diagram of FIG. 6. In FIG. 6, the circuit structure is such that the clock signal CLK′, which has been amplified to a required level by the amplifier 23, is superimposed onto the output signal Q and the inverse output signal /Q to be sent to the phase comparator 5 from the limiting amplifier 4′. Furthermore, as a modified example of the circuit structure of FIG. 6, by applying the clock signal CLK′ amplified by the amplifier 23 as a reference signal to the limiting amplifier 4′, the asynchronous noise may be superimposed onto each of the signals Q and /Q output from the limiting amplifier 4′. The circuit structure of this case is shown in the block diagram in FIG. 7.

Next is a description of a second basic structure of an input interruption detecting circuit of an optical receiver according to the present invention.

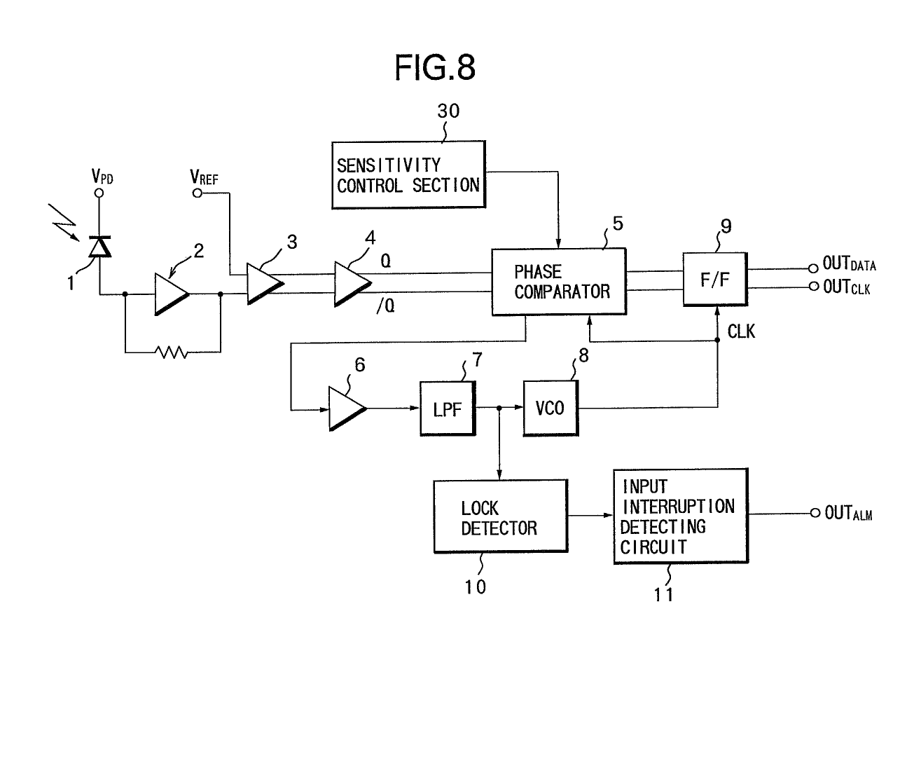

FIG. 8 is a block diagram showing the second basic structure of the present invention.

In FIG. 8, the second basic structure of the present invention is characterized in that a circuit structure similar to the conventional case shown in the abovementioned FIG. 22 is provided with a sensitivity control section 30 for reducing the sensitivity of the phase comparator 5 depending on the amplitude of the synchronous noise. Here, the sensitivity of the phase comparator 5 means the minimum amplitude of an input signal that enables the PLL circuit to be in a synchronous state. If the sensitivity of the phase comparator 5 is reduced depending on the amplitude of the synchronous noise, then the minimum amplitude of the input signal to which the phase comparator 5 can synchronize is increased, and thus it is difficult for the PLL circuit to synchronize depending on the synchronous noise.

Here, the arrangement is such that the sensitivity of the phase comparator 5 to be controlled by the sensitivity control section 30 is set to be equal to or greater than the sensitivity that enables the PLL circuit to synchronize due to the input of a received optical signal. In other words, the minimum amplitude of the input signal to which the phase comparator 5 can synchronize is set to be lower than the amplitude of the received optical signal. Furthermore, since the structure of the sections other than the sensitivity control section 30 is the same as in the case of the first basic structure, the description is omitted here.

With an optical receiver provided with the second basic structure as described above, in the case where the optical signal input is interrupted, the synchronous noise of a frequency that enables the PLL circuit to synchronize is input to the phase comparator 5. However, if the minimum amplitude of the input signal to which the phase comparator 5 can synchronize is greater than the amplitude of this synchronous noise, the PLL circuit enters an asynchronous state, and a situation of erroneous synchronization due to the influence of the synchronous noise is avoided. In this manner, the asynchronous state of the PLL circuit is detected by the lock detector 10, and an optical signal input interruption is judged by the input interruption detecting circuit 11, so that an input interruption detection alarm signal is output via the alarm output terminal OUT_{ALM} to outside. On the other hand, in a situation where an optical signal is input to the optical receiver, since the phase comparator 5 is set to have sufficient sensitivity for the received optical signal input to the phase comparator 5, the PLL circuit enters a synchronous state due to the received optical signal so that a clock signal CLK of a desired frequency is generated.

As is seen above, with the second basic structure of the present invention, since there is provided the sensitivity control section 30 that enables the sensitivity of the phase comparator 5 to be adjusted, in the case where the PLL circuit erroneously synchronizes to the synchronous noise easily at the time of an input interruption of the optical signal, the phase comparator 5 is adjusted by the sensitivity control section 30 in the direction where the sensitivity is reduced, and hence erroneous synchronization can be avoided. Here, the lower the sensitivity is made, the more uncertain the guarantee of synchronization of the PLL to a desired received optical signal becomes. However, since the arrangement is such that the sensitivity can be adjusted corresponding independently to the degree of influence of synchronous noise, the synchronization of the PLL to a desired received optical signal is not affected overall. Furthermore, by adjusting the sensitivity of the phase comparator 5, it is also possible to appropriately set the input light level at which an input interruption detection alarm signal is generated.

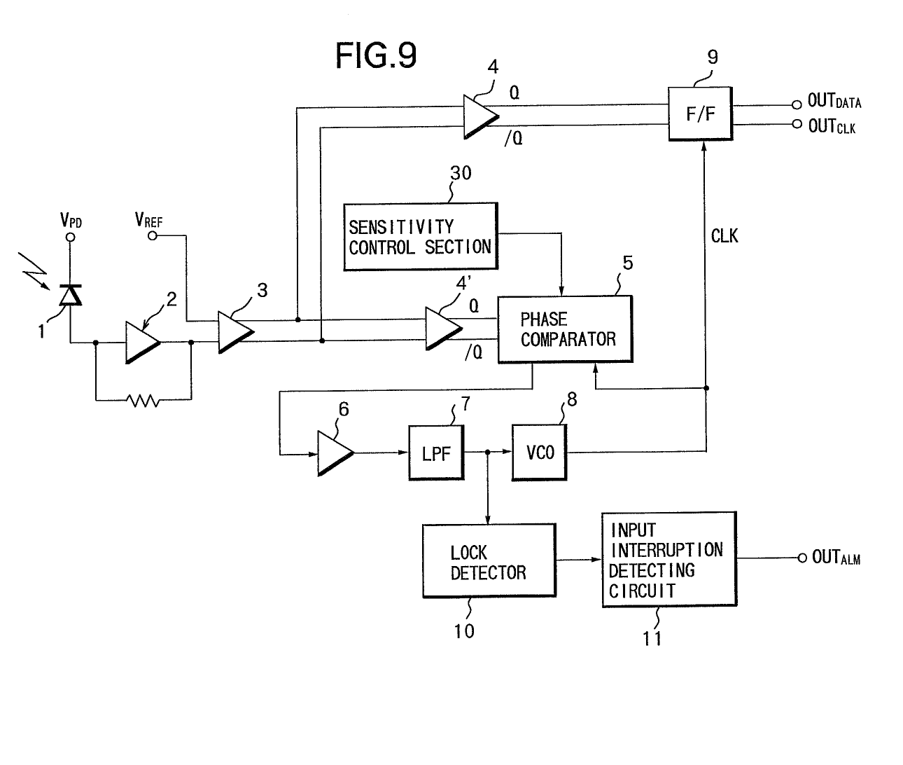

With the abovementioned second basic structure, similarly to the case shown in the aforementioned FIG. 2, the arrangement may also be such that the received signal to be sent to the PLL circuit is separated from the path of the main signal system where data identification processing is performed. The block diagram in FIG. 9 shows a modified example of this second basic structure.

Here is a description of a specific embodiment to which the second basic structure as described above is applied.

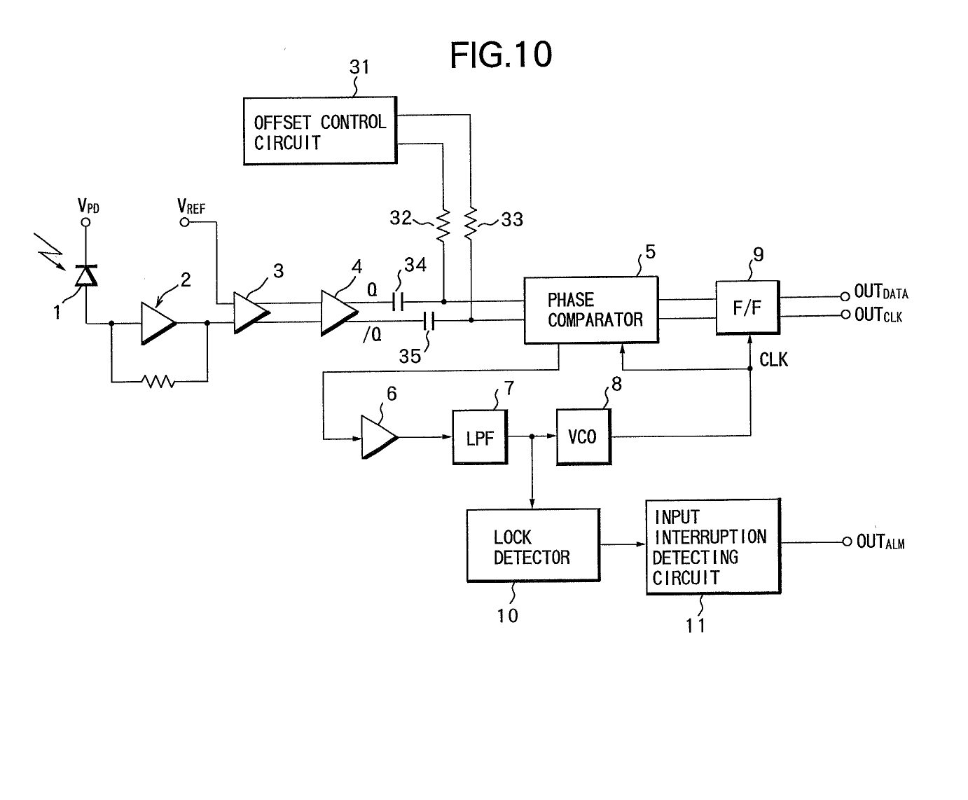

FIG. 10 is a block diagram showing the structure of an embodiment 2-1 of an optical receiver to which the second basic structure is applied.

In FIG. 10, the optical receiver of the embodiment 2-1 is provided with an offset control circuit 31, resistors 32 and 33, and capacitors 34 and 35 as a specific circuit structure of the sensitivity control section 30 in the aforementioned second basic structure shown in the FIG. 8.

The offset control circuit 31 generates an offset voltage of a variable level and applies the offset voltage to each input node of the phase comparator 5 via the resistors 32 and 33. The capacitors 34 and 35 are respectively inserted between the offset voltage application points and the output terminals of the limiting amplifier 4, and alternating current components of the signals Q and /Q output from the limiting amplifier 4 are transmitted to the phase comparator 5.

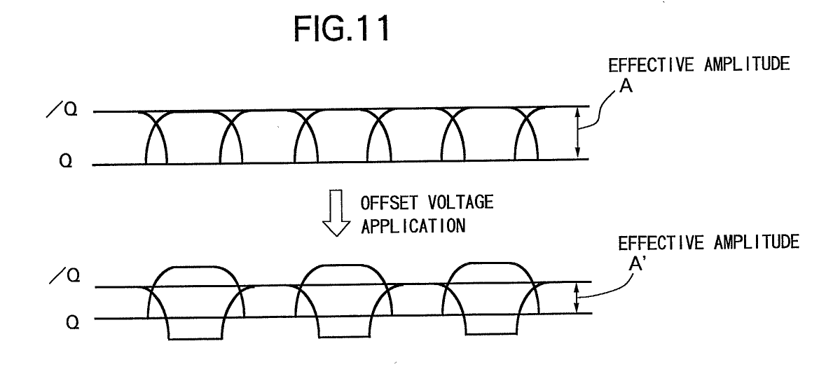

With the circuit structure as described above, by applying an offset voltage to each input node of the phase comparator 5, the effective amplitude of the input signal to the phase comparator 5 is reduced. More specifically, as shown in the upper part of FIG. 11, regarding the input signals to the phase comparator 5 before the offset voltage is applied, an amplitude corresponding to a difference between the high and low levels of each of the signals Q and /Q output from the limiting amplifier 4 is secured as an effective amplitude A for phase comparison. On the other hand, as shown in the lower part of FIG. 11, regarding the input signals to the phase comparator 5 after the offset voltage is applied, since direct current voltage levels of the signals Q and /Q are respectively shifted in opposite directions due to the offset voltage, the effective amplitude is reduced from A to A′. This effect that the effective amplitude is reduced by the application of offset voltage works both for the received optical signal input to the phase comparator 5 and for the synchronous noise. Therefore the effective amplitude of both the received optical signal input to the phase comparator 5 and the synchronous noise is reduced, which means that the minimum amplitude of the input signal to which the phase comparator 5 can synchronize is increased relatively.

Here, if the minimum amplitude of the input signal to which the phase comparator 5 can synchronize is set to a constant value, the offset voltage is adjusted such that the value of the minimum amplitude is less than the effective amplitude of the received optical signal after the offset voltage is applied. As a result, while the optical signal input is sustained, the PLL circuit enters a synchronous state due to the received optical signal, and when the optical signal input is interrupted, it is difficult for the PLL circuit to erroneously synchronize due to the synchronous noise so that an asynchronous state is realized, thus enabling adjustment that enables accurate input interruption detection based on the synchronous or asynchronous state of the PLL circuit.

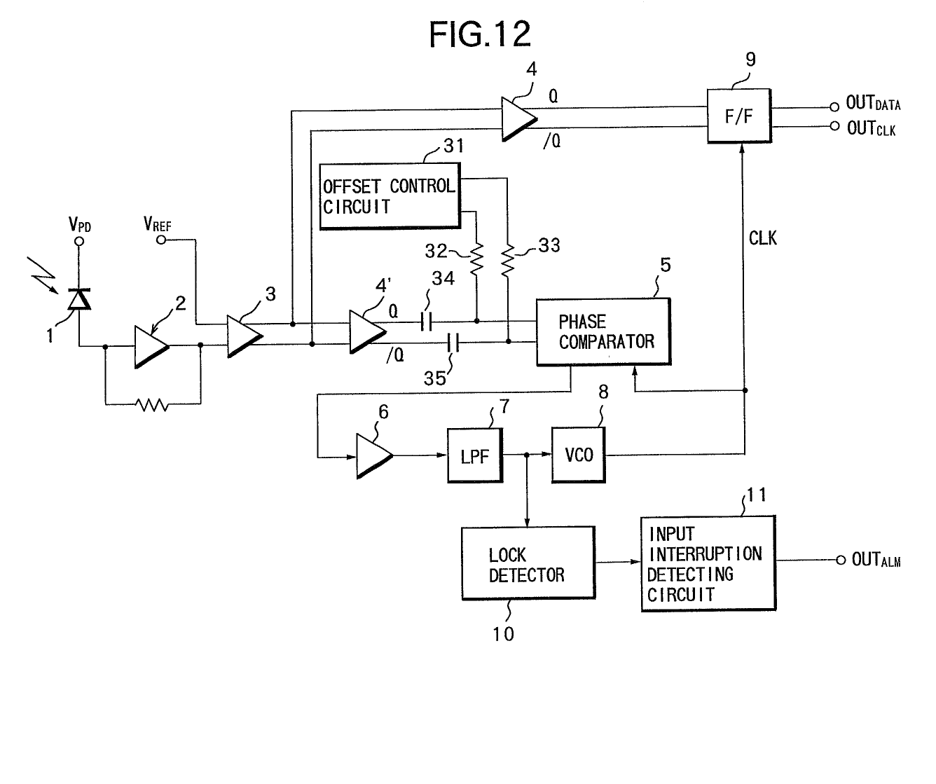

Note, a specific example corresponding to the aforementioned circuit structure shown in FIG. 8 is given in the above-described embodiment 2-1. However, a circuit structure as shown in FIG. 9 wherein the received signal to be sent to the PLL circuit is separated from the path of the main signal system, can also be applied similarly. A specific circuit structure of this case is shown in the block diagram in FIG. 12. In the circuit structure in FIG. 12, the offset voltage generated by the offset control circuit 31 is also applied, via the resistors 32 and 33, to each node between the capacitors 34 and 35 of the latter stage of the limiting amplifier 4′ and the input terminals of the phase comparator 5.

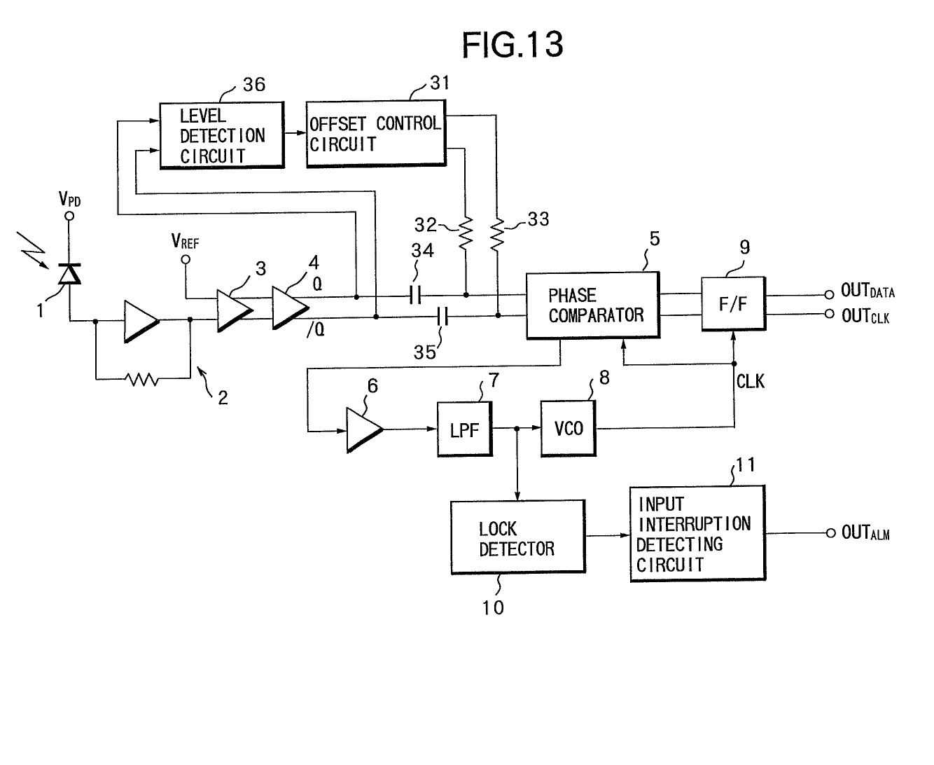

FIG. 13 is a block diagram showing the structure of an embodiment 2-2 of the optical receiver to which the second basic structure is applied.

In FIG. 13, the optical receiver of the embodiment 2-2 is provided with a level detection circuit 36 for detecting the level of each of the signals Q and /Q output from the limiting amplifier 4, in a circuit structure of the embodiment 2-1 shown in the aforementioned FIG. 10, and the offset voltage generated by the offset control circuit 31 is automatically controlled in accordance with a detection result of the level detection circuit 36. More specifically, the offset control circuit 31, when judges that the level of the optical signal input to the present optical receiver is reduced to a level corresponding to an input interruption, based on the detection result of the level detection circuit 36, controls the offset voltage to be increased. As a result, the effective amplitude of the input signal to the phase comparator 5 is reduced, and hence the sensitivity of the phase comparator 5 becomes comparatively lower than when the optical signal is input. Therefore, erroneous synchronization of the PLL circuit due to the synchronous noise is avoided, enabling accurate input interruption detection.

In this manner, if the level of the received optical signal is detected and the offset voltage is automatically controlled, even if for example the operating points of each of the amplifiers 2 through 4 fluctuate, an appropriate offset voltage can be applied, and hence it is possible to perform optical signal input interruption detection stably.

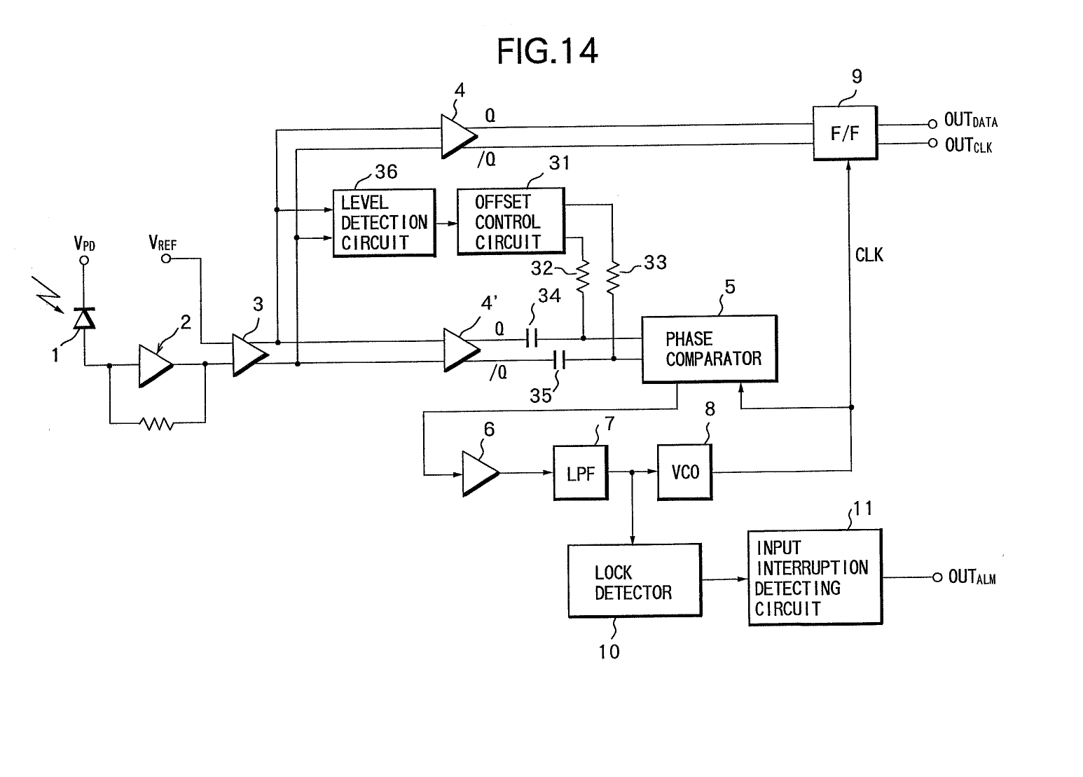

For the circuit structure of the abovementioned embodiment 2-2, the circuit structure wherein the received signal to be sent to the PLL circuit shown in the aforementioned FIG. 12 is separated from the path of the main signal system can also be applied similarly. A specific circuit structure of this case is shown in the block diagram in FIG. 14. In FIG. 14 for example, the level detection circuit 36 detects the level of the signal output from the main amplifier 3 to the limiting amplifier 4, and the detection result is transmitted to the offset control circuit 31.

Furthermore, in the abovementioned embodiments 2-1 and 2-2, the offset voltage is applied between the limiting amplifier 4 and the phase comparator 5. However, the position of the offset voltage application is not limited to this. The offset voltage may be applied at any arbitrary position on the prior stage of the phase comparator 5.

Next is a description of a third basic structure of an input interruption detecting circuit of an optical receiver according to the present invention.

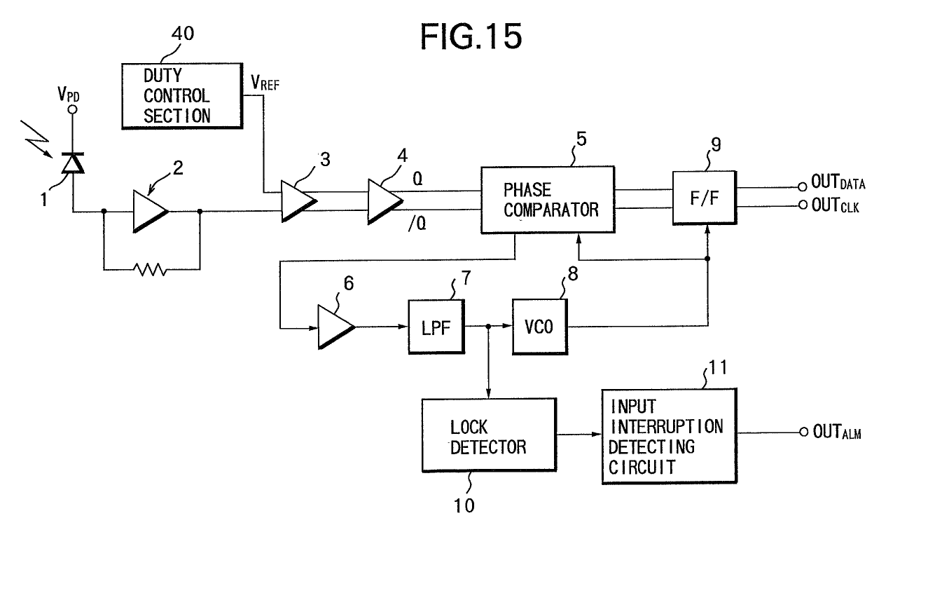

FIG. 15 is a block diagram showing the third basic structure of the present invention.

In FIG. 15, the third basic structure of the present invention is characterized in that there is provided a duty control section 40 for controlling a duty ratio of the signal input to the phase comparator 5, in a circuit structure similar to the conventional case shown in the abovementioned FIG. 22. This duty control section 40 variably controls the duty ratio of the signal input to the phase comparator 5, for example by adjusting the reference voltage V_{REF} of the main amplifier 3 or the like. More specifically, if the duty ratio of an optical signal input to the present optical receiver is set to 100%, the duty control section 40 controls the duty ratio of the signal output from the main amplifier 3 to be reduced by shifting slightly the reference voltage V_{REF} of the main amplifier 3 from the center voltage value of received data. Here, the duty ratio is a ratio when the data of the optical signal input becomes at a high level (optical signal is on) during one time slot.

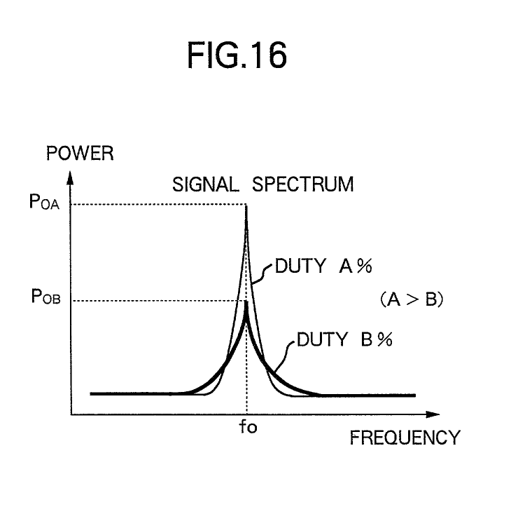

If the duty ratio of the signal input to the phase comparator 5 is reduced in this manner, it is possible to reduce the power of the center frequency component of the input signal. That is to say, as shown in FIG. 16 for example, in the case where the duty ratio is controlled from A % to B % (A>B), if the spectrum of the input signal is considered, the power level of the center frequency f₀ component is reduced from P_{0A} to P_{0B}. This effect where the power of the center frequency f₀ component is reduced by controlling the duty ratio works both for the received optical signal input to the phase comparator 5 and for the synchronous noise.

Accordingly, with regard to the input signal to the phase comparator 5, if the minimum power of the frequency component to which the PLL circuit can synchronize is set to a predetermined value, by controlling the duty ratio within a range where the minimum power value is lower than the power of the center frequency f₀ component of the received optical signal after the duty ratio is adjusted, the PLL circuit enters an asynchronous state regardless of the synchronous noise, even at the time of an input interruption of the optical signal.

In this manner, with the third basic structure of the present invention wherein the duty control section 40 is provided to control the duty ratio of the signal input to the phase comparator 5 in accordance with spectrum of the synchronous noise, so that it is difficult for the PLL circuit to erroneously synchronize due to the synchronous noise, and hence an optical signal input interruption can be detected accurately based on the synchronous or asynchronous state of the PLL circuit. Furthermore, by adjusting the duty ratio of the signal input to the phase comparator 5, it is also possible to appropriately set the input light level at which the input interruption detection alarm signal is generated.

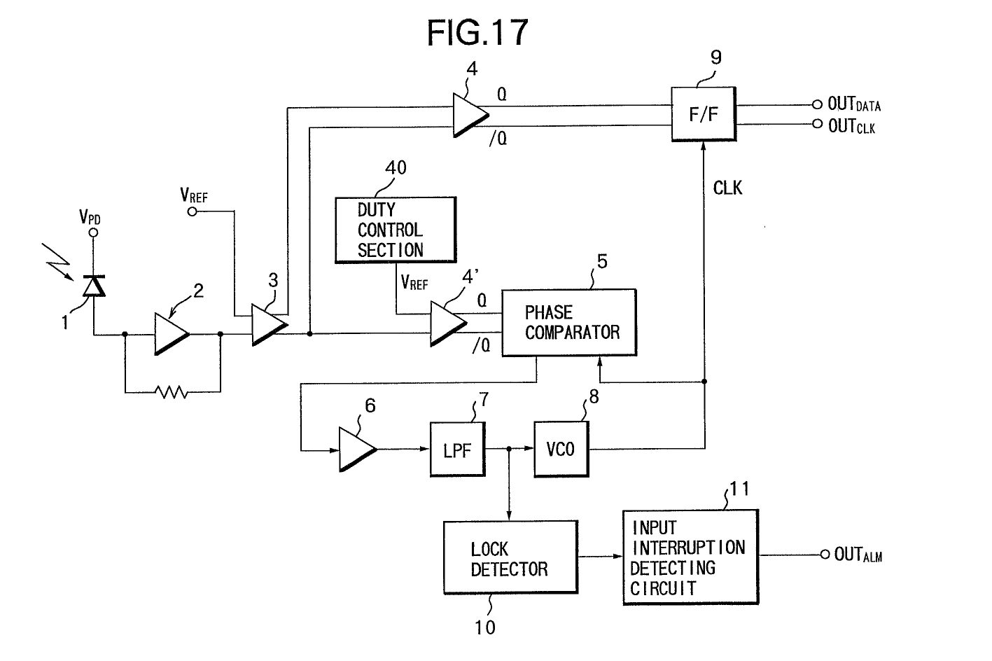

Note, in the abovementioned third basic structure, similarly to the case shown in the aforementioned FIG. 2, the arrangement may also be such that the received signal to be sent to the PLL circuit is separated from the path of the main signal system where data identification processing is performed. The block diagram in FIG. 17 shows a modified example of this third basic structure. In FIG. 17, the arrangement is such that the duty control section 40 controls the duty ratio of the signal input to the phase comparator 5 by adjusting the reference voltage V_{REF} of the limiting amplifier 4′.

Here is a description of a specific embodiment to which the third basic structure as described above is applied.

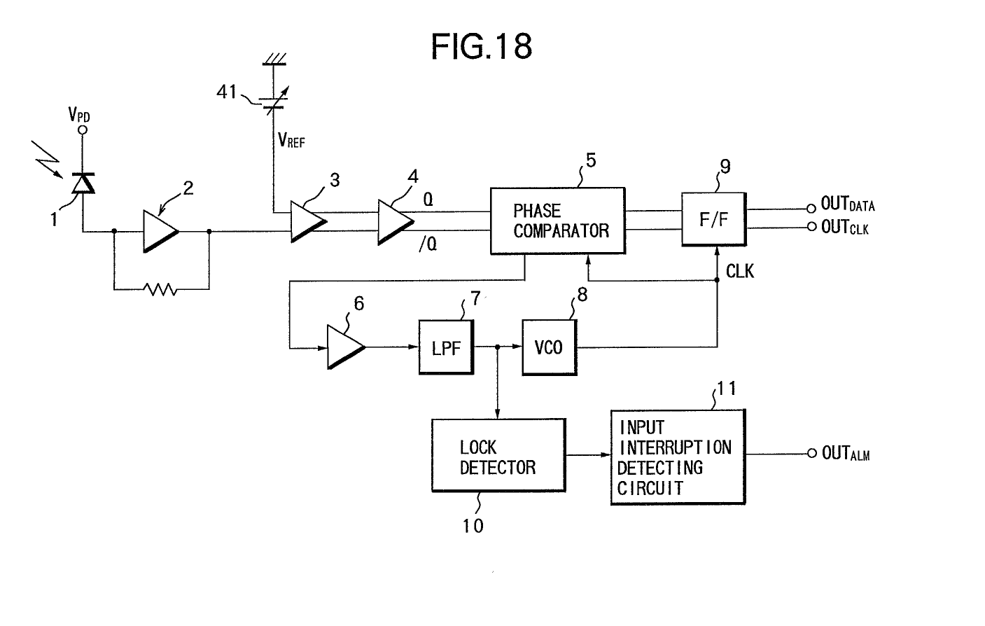

FIG. 18 is a block diagram showing the structure of an embodiment 3-1 of the optical receiver to which the third basic structure is applied.

In FIG. 18, the optical receiver of the embodiment 3-1 is provided with a variable power source 41 between the reference input terminal of the main amplifier 3 and the ground terminal, as a specific circuit structure of the duty control section 40 in the third basic structure shown in the aforementioned FIG. 15. By adjusting the reference voltage V_{REF} to be applied to the main amplifier 3 with the variable power source 41, to control the duty ratio of the signal input to the phase comparator 5, then as mentioned above, the power of the center frequency component of the synchronous noise is set to be lower than the minimum power at which the PLL circuit can synchronize, and hence erroneous synchronization due to the synchronous noise at the time of an input interruption is avoided.

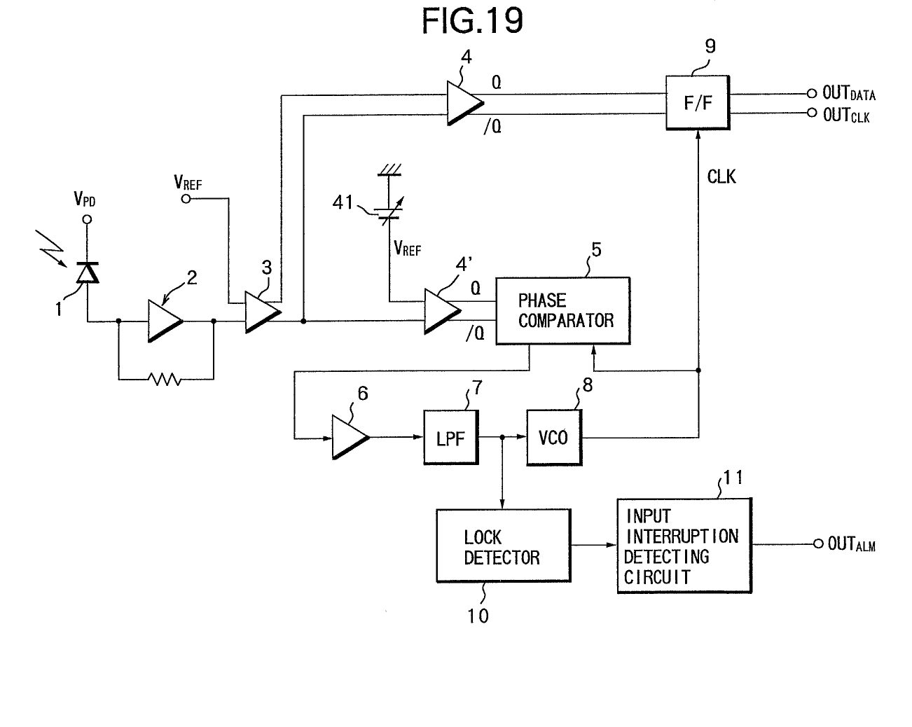

Here, in the modified example of the third basic structure shown in the aforementioned FIG. 17, similarly to the case of the abovementioned embodiment 3-1, the variable power source 41 can be used for the duty control section 40. A specific circuit structure of this case is shown in the block diagram of FIG. 19.

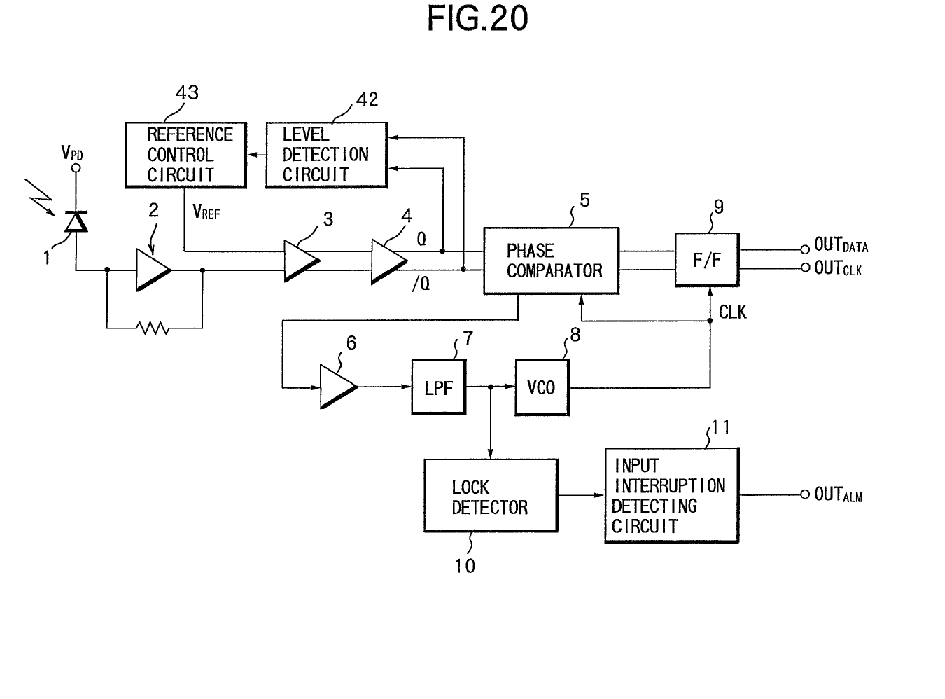

FIG. 20 is a block diagram showing the structure of an embodiment 3-1 of the optical receiver to which the third basic structure is applied.

In FIG. 20, the optical receiver of the embodiment 3-1 is provided with a level detection circuit 42 for detecting the levels of the signals Q and /Q output from the limiting amplifier 4, and a reference control circuit 43 for automatically controlling the reference voltage V_{REF} to the main amplifier 3 in accordance with the detection result of the level detection circuit 42, instead of the variable power source 41, in the circuit structure of the embodiment 3-1 shown in the aforementioned FIG. 18. More specifically, the reference control circuit 43, when judges based on the detection result of the level detection circuit 42 that the level of the optical signal input to the present optical receiver is reduced to a level corresponding to an input interruption, increases the reference voltage V_{REF} to the main amplifier 3 to a predetermined level to control the duty ratio of the signal input to the phase comparator 5. As a result, even at the time of an input interruption of the optical signal, erroneous synchronization due to the synchronous noise is avoided.

In this manner, if the level of the received optical signal is detected and the reference voltage V_{REF} is automatically controlled, even if for example the operating points of each of the amplifiers 2 through 4 fluctuate, the duty ratio of the signal input to the phase comparator 5 is controlled appropriately, and hence it is possible to perform optical signal input interruption detection stably.

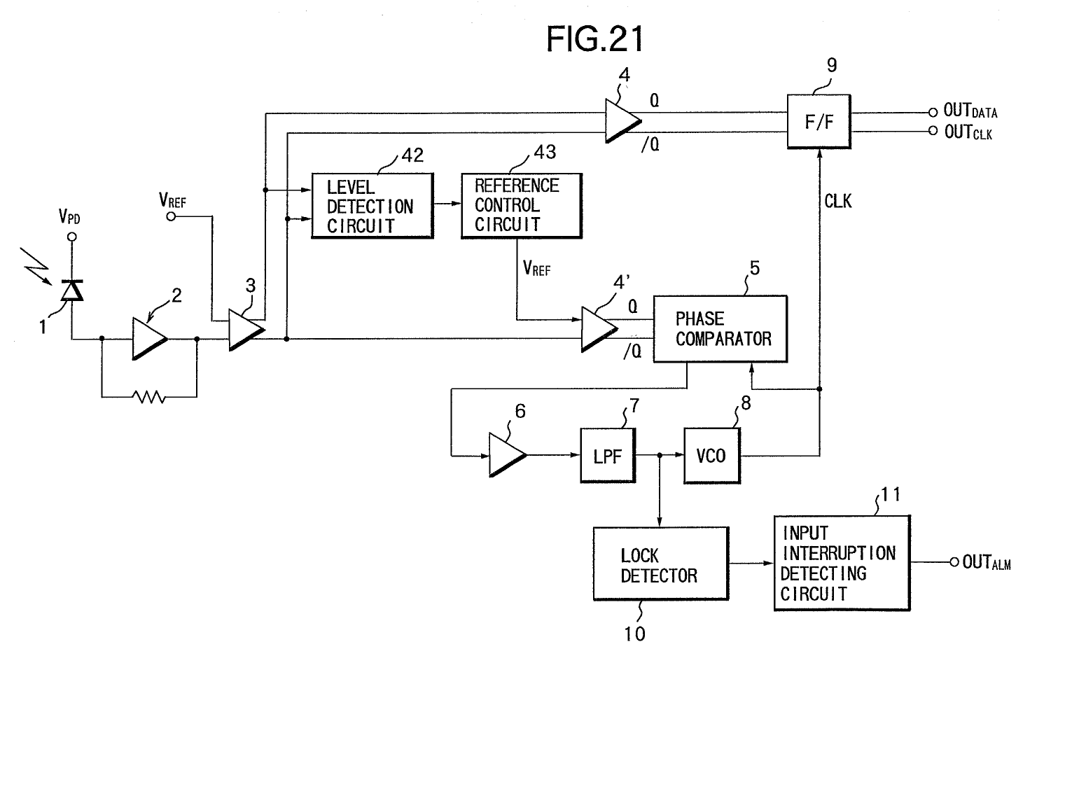

Also in the modified example of the embodiment 3-1 shown in the aforementioned FIG. 19, similarly to the case of the abovementioned embodiment 3-2, it is possible to provide the level detection circuit 42 and the reference control circuit 43 instead of the variable power source 41. A specific circuit structure of this case is shown in the block diagram in FIG. 21. In FIG. 21 for example, the level of the signal output to the limiting amplifier 4 from the main amplifier 3 is detected by the level detection circuit 42, and the detection result is transmitted to the reference control circuit 43.

Furthermore, in the abovementioned embodiments 3-1 and 3-2, the reference voltage of the main amplifier 3 is adjusted. However, the present invention is not limited to this, and the arrangement may be such that the reference voltage of the limiting amplifier 4 is adjusted to control the duty ratio of the signal input to the phase comparator 5.

What is claimed:

1. An input interruption detecting circuit of an optical receiver for detecting an input interruption of an optical signal based on the synchronous or asynchronous state of a phase locked loop circuit which generates a timing signal using a received optical signal, comprising;
a noise superimposition section which superimposes an asynchronous noise having frequency components that make said phase locked loop circuit asynchronous, onto a signal input to a phase comparator of said phase locked loop circuit.

2. An input interruption detecting circuit of an optical receiver according to claim 1, wherein said noise superimposition section superimposes the dark current generated by a photodetector which converts received optical signals to electrical signals, onto the input signal of said phase comparator as said asynchronous noise.

3. An input interruption detecting circuit of an optical receiver according to claim 2, wherein
said photodetector is an avalanche photodiode, and
said noise superposition section has a level detection circuit for detecting a level of a received optical signal, and a reverse bias control circuit for controlling a reverse bias value applied to said avalanche photodiode in accordance with a detection result of said level detection circuit.

4. An input interruption detecting circuit of an optical receiver according to claim 1, wherein said noise superposition section generates said asynchronous noise using a timing signal generated by said phase locked loop circuit, and superimposes this onto said input signal to said phase comparator.

5. An input interruption detecting circuit of an optical receiver for detecting an input interruption of an optical signal based on the synchronous or asynchronous state of a phase locked loop circuit which generates a timing signal using a received optical signal, comprising;
a sensitivity control section for adjusting the sensitivity of a phase comparator of said phase locked loop circuit.

6. An input interruption detecting circuit of an optical receiver according to claim 5, wherein
said sensitivity control section has an offset control circuit for applying an offset voltage corresponding to a level of a signal input to said phase comparator, to a signal input to said phase comparator, and
said offset control circuit increases said offset voltage when a level of said input signal becomes small.

7. An input interruption detecting circuit of an optical receiver according to claim 6, wherein
said sensitivity control section has a level detection circuit for detecting a level of a received optical signal, and said offset control circuit controls the offset voltage in accordance with a detection result of said level detection circuit.

8. An input interruption detecting circuit of an optical receiver for detecting an input interruption of an optical signal based on the synchronous or asynchronous state of a phase locked loop circuit which generates a timing signal using a received optical signal, comprising;
a duty control section for controlling a duty ratio of a signal input to a phase comparator of said phase locked loop circuit.

9. An input interruption detecting circuit of an optical receiver according to claim 8, wherein
said duty control section has a reference control circuit for controlling a reference voltage applied to an amplifier which amplifies a received optical signal and sends this to said phase comparator, and said reference control circuit increases the reference voltage of said amplifier when a level of a signal input to said phase comparator becomes small.

10. An input interruption detecting circuit of an optical receiver according to claim 9, wherein
said duty control section has a level detection circuit for detecting a level of a received optical signal, and said reference control circuit controls the reference voltage in accordance with a detection result of said level detection circuit.
